(19) United States
(12) Patent Application Publication
(10) Pub. No.: US 2025/0068888 A1
(43) Pub. Date: Feb. 27, 2025

(54) LEARNING RELATIONS IN MULTI-RELATIONAL GRAPHS IN GRAPH NEURAL NETWORKS

(71) Applicant: International Business Machines Corporation, Armonk, NY (US)

(72) Inventors: Christos Theodoropoulos, Brussels (BE); Marco Luca Sbodio, Castaheany (IE); Natalia Mulligan, Dublin (IE); Joao H Bettencourt-Silva, Dublin (IE)

(21) Appl. No.: 18/452,969

(22) Filed: Aug. 21, 2023

(51) Int. Cl. G06N 3/0464

(52) U.S. Cl. CPC G06N 3/0464

(57) ABSTRACT

An approach for determining how well a graph neural network (“GNN”) learns a relation in a multi-relational graph (“MRG”) and generating a generalized relation to substitute in the MRG to more effectively train the GNN to learn the relation. Layers of interest in a GNN may be identified along with which parameters to monitor based on the architecture of the GNN and the model type of the MRG. A MRG may be input into the GNN to generate embeddings for the entities and relations of the MRG. A comprehension score can be generated for the relations and the relations can be ranked. A more generalized relation can be identified for relations ranked below a threshold and can be substituted into the multi-relation graph in place of the lower ranked more specific relations. The updated MRG can be input into the graph neural network to further train the GNN.

### BACKGROUND

The present invention relates to multi-relational graphs, and more specifically, to learning the relationships between entities within graph neural networks. Graphs are data structures which formally represent a network. In other words, it is a collection of interconnected objects. Graphs are made up of entities, these entities are called nodes or vertices. The entities are connected by some form of relation normally a line connecting them which are called edges. In the real world, graphs are typically multi-relational (i.e., consist of more than one type of relation connecting nodes). The entities of a multi-relational graph have different semantics for each relation between them. Prediction tasks, such as graph classification and node classification, require effective vector representation (i.e., embeddings) of these relations. In many cases, these vector representations are acquired via a graph neural network.

Cognitive models such as machine learning models and artificial intelligence have been developed to provide computer interpretable meaning to spoken language. In many cases these models utilize neural networks with various architectures to accomplish this task. Neural networks composed of more than two layers are considered deep neural networks. Deep neural networks take on many complex architectures with the end goal of providing a vector representation within a multi-dimensional space. In most cases words with similar meaning are grouped together within this space. Typically, the domain in which a cognitive model is trained requires a great deal of training data which can be labelled by a human. In these training sequences, a human may provide supervision of the training which is called supervised training. In another method of training cognitive models, unlabeled data may be provided, and the cognitive model then assigns meaning to the data in accordance with provided parameters. This is called unsupervised training.

### SUMMARY

Embodiments of the present invention may include, a computer-implemented method, a computer program product and a computer system for generating an updated multi-relational graph neural network with generalized relations for relations not well learned by a graph neural network to more effectively train a graph neural network to learn the relations. Embodiments of the present invention may include receiving, at a definition module an input, wherein the input is a model architecture of a graph neural network, model type of the graph neural network, a hierarchy/ontology/taxonomy of relations or entities. Embodiments may also include identifying, by the definition module, one or more layers of interest in the graph neural network and a plurality of parameters to monitor, based on the model architecture and model type. Embodiments also include embedding of the nodes of the graph neural network, a multi-relational graph, wherein the multi-relational graph comprises a plurality of entities and relations between entities. Embodiments may also include monitoring, by the monitoring module, the one or more layers of interest and the plurality of parameters of the graph neural network embedding a multi-relational graph. Embodiments may also include generating, by the monitoring module, a comprehension score for each of a plurality of relations in the multi-relational graph, based on the monitoring. Embodiments may also include generating, by the monitoring module, a ranked relation list, based on the comprehension score. Embodiments may also include generating, by a relation generalization module, a more general relation for each relation below a ranking threshold, wherein the more general relation is taken from the input hierarchy/ontology/taxonomy of relations or entities. Embodiments may also include generating, by the relation generalization module, a first updated multi-relation graph based on the generated generalized relation. Embodiments may also include embedding the first updated multi-relational graph, based on the graph neural network.

### BRIEF DESCRIPTION OF THE DRAWINGS

FIG. 1 is a functional block diagram of a computing environment, generally designated 100, in accordance with an embodiment of the present invention.

FIG. 2A is a functional block diagram of a multi-relational graph relation generation engine, generally designated 200, in accordance with an embodiment of the present invention.

FIG. 2B is a block diagram depicting the monitors and ranker of monitor module 214, in accordance with an embodiment of the present invention.

FIG. 3 is a flowchart of a method identifying poorly understood relations and providing suggestions to generalize the poorly understood relations.

### DETAILED DESCRIPTION

Real-world graphs are generally multi-relational. They may be directed or undirected graphs. In many cases a graph may possess several types of relations between entities, each of these relations may have a different semantics (i.e., meaning). In many prediction-based tasks (e.g., graph classification, node classification, etc.) learning an effective representation of the graph's relations is a top priority. Graphs themselves are representations of networks that are comprised of entities (e.g., nodes or vertices) and relations between entities (e.g., edges). It should be noted, to prevent any confusion, throughout this disclosure the term entity shall be used to describe the nodes or vertices of a multi-relational graph. The term edge and relation shall be used interchangeably and should be afforded the appropriate definition.

A multi-relational graph can be provided to a graph neural network (“GNN”). An input layer of a GNN may define the initial representations of graph data. For example, the input layer may assign feature representations to entities and edges of a multi-relational graph. The input layer may receive one or more data structures that can be understood by the GNN. For example, the input layer may transform a graph into an incident matrix, edge list, adjacency matrix, adjacency list, or any format understood by the GNN. Further, the input layer may assign vector representations in a d-dimensional space to an entity or relation, where d can correspond to any number of dimensions (e.g., 1, 2, n . . . n+1). The initial embedding can be random or directed, based on past training of the input layer or assigned at random. This process is also called embedding the entity or relation in a d-dimensional space. The entity or relation representations can be performed through a linear transformation or the like.

GNNs can be configured to update vector representations of the entities and relations. This can be accomplished through the aggregation of features of neighboring entities and relations. Further, the update may occur through the process of recursive neighborhood diffusion where each update to an entity or relation may cause a nudge or modification of through the edges resulting in the nodes in a given section of the graph structure being updated. The diffusion causes the largest changes to the nodes closest to the updated node, while the magnitude of changes diminish the further away from node. Furthermore, a GNN learns about each relation on each layer independently of other relations. For example, a GNN for multi-relations can update features independently for each relation and then fuse them together and propagate to the following layer which may split again. Additionally, graph embedding updates can occur via tuning for an output layer after the GNN associated with prediction tasks and back propagated through the output layer and GNN.

In an embodiment of the present invention, for an input graph with entities and entities present within the graph additional input hierarchies may suggest a generalization of relations which may improve the learning of the corresponding representations when training a GNN with the input graph. In an embodiment, the approach may identify and rank relations in a multi-relational graph according to how effectively the GNN learns the embeddings of the relations. Furthermore, in an embodiment, the approach may suggest generalizations of relations with poorly understood embedding which are used in the multi-relational graph. The generalizations may result in an improvement of the learning of the corresponding relational embeddings and neighboring entities and relations when training a graph neural network on the multi-relational graph.

Embodiments of the present invention may comprise a method, system, and/or a computer program product which may rank relations in a multi-relational graph based on how effectively a graph neural network can learn the latent representation on each layer (i.e., learn the features of each relation). Further, some embodiments may suggest generalizations of relations used in a multi-relational graph to improve learning of the corresponding latent representation of the relation and the surrounding relations when training a graph neural network on a multi-relational graph.

Embodiments of the present invention may take as an input a multi-relational graph, a graph neural network, a hierarchy/ontology/taxonomy of relations and/or entities, and a set of optional parameters/function to configure the ranking and generalization of relations. It should be noted, when the optional parameters or functions are not given as input, the approach may use default parameters and functions associated with the GNN.

In an embodiment, an output may be produced as a set of suggestions on how to generalize relations used in a multi-relational graph to improve learning of the relations in the GNN. For example, an embodiment may produce a suggestion to include: a pair of relations (e.g., r, R) where r is used in a multi-relational graph, but the graph neural network cannot effectively learn its vectorized representation, and R is a broader relation than r (e.g., according to some input hierarchy/ontology/taxonomy). The GNN can learn more effectively a latent representation of R (i.e., it has a better understanding of R, than r). In other words, how well the relation is learned corresponds to how well the GNN has tailored the latent features for each relation type on either all layers or just on the layers of interest. Furthermore, an embodiment may produce, a pair of scores (s_r, s_R) that quantify the effectiveness of the learning of the vectorized representation learned by the graph neural network for r and R, respectively. Further yet, an embodiment may generate a human interpretable explanation of the suggestion based on the scores (s_r, s_R) and the hierarchy/ontology/taxonomy that r and R. In another embodiment, the approach may store user reviews (accept/reject/modify) of the proposed suggestions and may use such information to update the approach for future ranking and/or suggestions of relation generalizations.

In one or more embodiments of the present invention, operations may require one or more input parameters, however, optional parameters may be input as well, such as, the model architecture and the model type of the GNN. It should be noted, if input parameters are not provided all relations can be inspected. Further, an embodiment may incorporate identifying the “Relations of Interest”. For example, the embodiment may utilize a definition module comprising a database, knowledge graph, or the like, of multi-relational graph model architecture, model type, relations of interest. The data associated with the relations of interest may point to specific data within a GNN such as layers of interest within the GNN, as well as, monitored parameters associated with the multi-relational graph and the graph neural network. Additional input parameters may include observing or defining the monitoring strategy, model parameters, weight update calculation strategy, score aggregation strategy, final score aggregation strategy, relation hierarchy, and/or entity hierarchy and the like of the GNN.

In an embodiment, if the monitored parameters of the GNN are “convolution weights” or “transformation trainable parameters” then the approach may extract the weights from the layers of interest and based on the model parameters and monitoring strategy the system may calculate the weight update (i.e., the delta). Based on the weight changes and the direction of the weight change, the system can make a determination of how well the relations are being learned. Additionally, in an embodiment, the aggregated calculated weight updates can be transformed into final scores where the final scores reflect how well a relation has been learned by the GNN.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

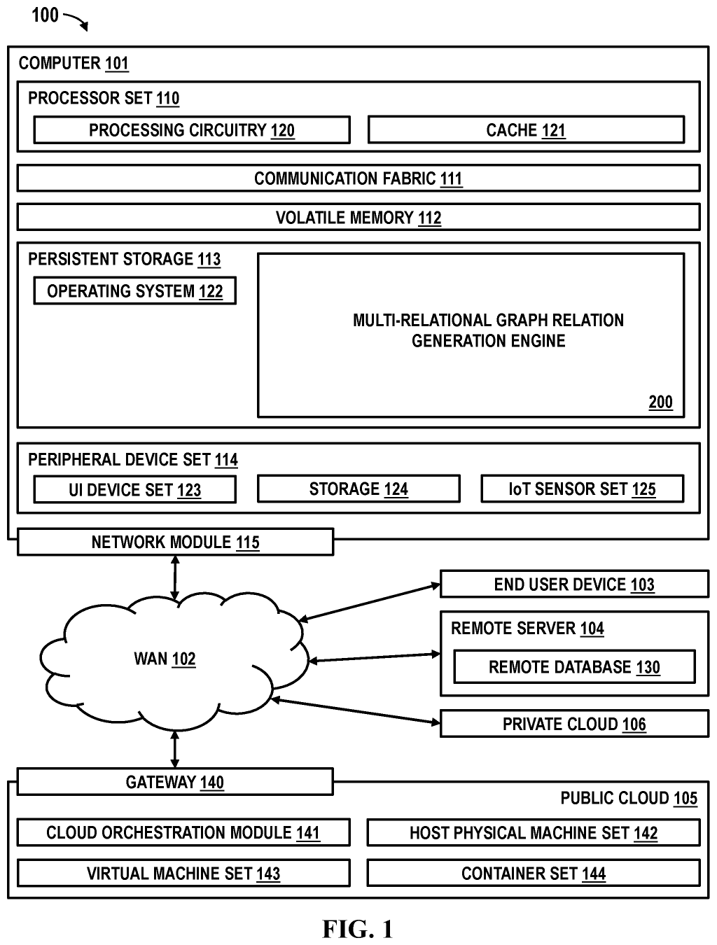

Now with reference to FIG. 1. FIG. 1 is a block diagram of Computing environment 100 which contains an example of an environment for the execution of at least some of the computer code involved in performing the inventive methods, such as multi-relational graph relation generation engine 200. In addition to multi-relational graph relation generation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

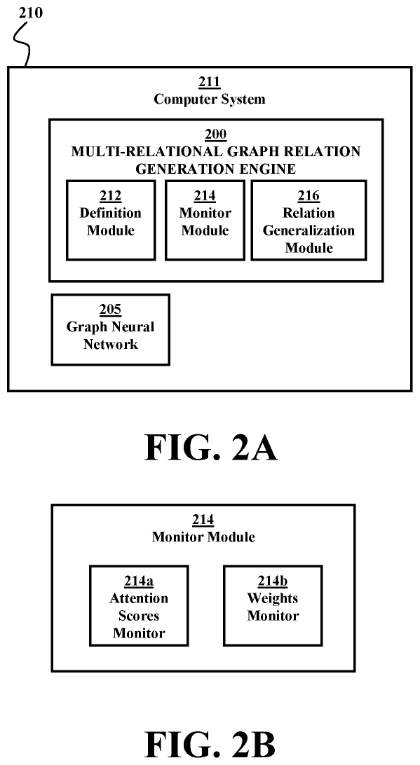

FIG. 2 is a block diagram of an environment for suggesting more generalized relations in a multi-relation graph when more fine grained relations are not learned well by a GNN 210. Shown in environment 211 is computer system 200. Computer system 211 can be a general purpose computer or a computer with capabilities as described in computer 101 in FIG. 1. Operational on computer system 211 is multi-relational graph relation generalization suggestion engine 200, graph neural network 205, and database 220. Shown operational on multi-relational graph generation engine 210 is definition module 212, monitor module 214, and relation generalization module 216 (described further below).

In an embodiment, definition module 212 is a computer module, which can be configured to identify layers of interest and associated parameters of the layers of interest within a GNN (i.e., graph neural network 205). A layer of interest is a list with the identities of the layers in GNN 205 which will be monitored. The associated parameters of the layers of interest are the parameters which will be monitored and can be based on the model architecture.

Definition module 212 may receive one or more inputs. Inputs may be the model architecture, the model type of the GNN, and the relation of interest in the multi-relational graph. Examples of the model architecture can be one or more identified layers within the model (e.g., GCN_patient_hasDisease_disease). Further, Definition module 212 may receive the model type. The model type can be the type of model for GNN 205 (e.g., graph convolutional network (“GCN”), graph attention network (“GAT”), etc.). In an embodiment, specific relations of interest in the multi-relational graph may be input or all relations can be monitored. In an embodiment, definition module 212 identify the layer of interest (e.g., the convolution, attention mechanism, or the like) which corresponds to the transformation of the input relation of interest. Further, definition module can identify the parameters associated with the transformation. The parameters will correspond to the model type of GNN 205 (e.g., convolution weights, attention weights or scores, or other transformation trainable parameters of a GNN).

In an embodiment, monitor module 214 is a computer module, operational on multi-relational graph relation generation engine 200. Monitor module 214 can receive the output of the definition module 212 as inputs and monitor GNN 205 during training or execution of embedding the entities and relations of a multi-relation graph and generate a level of comprehension associated with each relation. The level of comprehension is a quantification of how well the relation in learned by GNN 205. Further, in an embodiment, each relation may be ranked based on the level of comprehension, where the relations that have a lower comprehension level correspond to the relation not being learned as well by GNN 205. In an embodiment, monitor module 214 may receive the layers of interest and the parameters to monitor from definition module 212. Monitor module 214 may monitor these layers and parameters of GNN 205 while GNN 205 embeds or vectorizes a multi-relational graph.

FIG. 2B shows capabilities associated with monitor module 214 in accordance with some embodiments of the invention. Attention score monitor 214a is a monitor that can be operational on monitor module 214. Attention score monitor 214a can be utilized if definition module 212 provides a graph neural network model type is an attention based graph neural network. Attention score monitor 214a can monitor the parameters and methodology for attention scores associated with the input layers of interest, for an attention based graph neural network. Further, attention score monitor 214a can monitor the attention score aggregation strategy regarding the layers of interest and the identified parameters during the development of the embedding. Even further, Attention score monitor 214 can monitor or analyze the final score (e.g., a tensor) associated with aggregation strategy Attention score monitor 214a can take a mean of the attention score (e.g., score aggregation) obtained during monitoring. From the monitoring, Attention score monitor can generate a list of final scores associated with the attention scores providing insights into the graph neural network's ability to learn specific relations between entities.

Weight monitor 214b is a monitor that can be operational on monitor 214. Weight monitor 214b can be operational if the input layers of interest and the parameters to monitor are associated with a GNN model such as a graph convolutional network. Weight monitor 214b can take a snapshot of the weights of interest in a layer of interest of specific epochs (e.g., epoch 1, 10, 20, etc). Weight monitor 214b can also compare the weight update calculation strategy. For example, weight monitor 214b may determine the absolute difference of one or more parameters in an epoch (e.g., |w1|−|w2|). Weight monitor 214b may generate a final score and level of comprehension for every relation within the multi-relation graph.

In an embodiment, relation generalization module 206 is a computer module, operational on multi-relational graph relation generation engine 200. Relation generalization module can generate a suggested generalization of relations used in the multi-relation graph and based on additional inputs that may include entities-hierarchy and relations-hierarchy. Further in another embodiment, relation generalization module 206 may generate an updated multi-relational graph or a new multi-relational graph with the generalized relations based on the output of monitoring module 204. In an embodiment, relation generalization module 206 may use a subsumption hierarchy to generalize relations and determine the compatibility of the domain and/or range. For example, if “is_sister_of” receives a low ranking or confidence score, it may be replaced by a higher ranked relation (e.g., “is_sibling_of” or “is_relative_of”) within the same domain, though it is not as specific.

In an embodiment, relation generalization module 206 may present the updated or new multi-relational graph to a user for acceptance of the change. If the change is accepted, relation generalization module 206 may save the results in a database such as persistent storage 113 or remote database 130 and utilize the results for future reinforcement learning associated with the cognitive models of multi-relational graph relation generation engine 200.

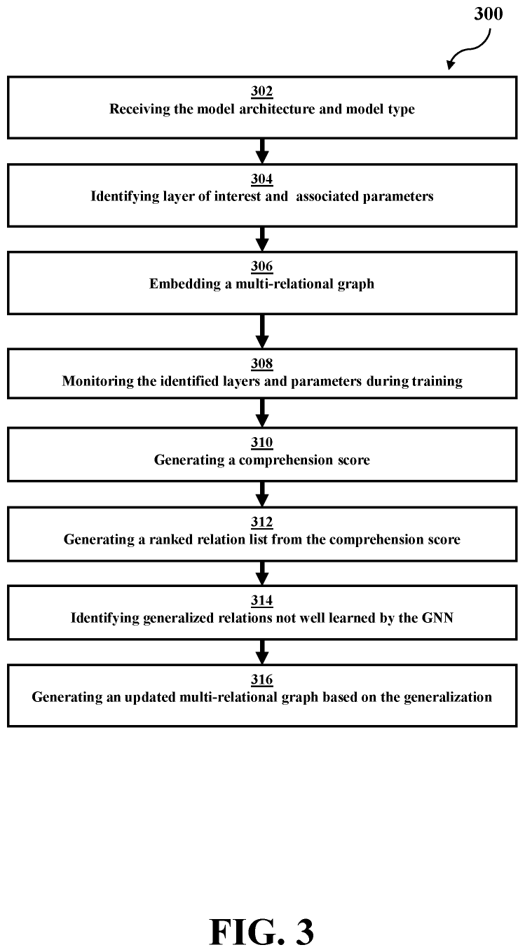

FIG. 3 is flowchart 300 showing the steps of an approach consistent with the present disclosure according to an embodiment of the invention. At step 302, at a definition module receive an input, for example, the input can be one or more multi-relational graphs, a model architecture of a graph neural network and model type of the graph neural network. At Step 304, identify one or more layers of interest and a plurality of parameters to monitor. For example, the definition module based on the model architecture and model type can identify the layers of interest and the parameters associated with the layers of interest associated with the model type and graph architecture of graph neural network 205. At step 306, embed by the graph neural network, a multi-relational graph. For example, graph neural network 205 can process graphs and generate embedding or embeddings. or vectorizing the entities and associated relations in the multi-relational graph. At step 308, monitor the identified one or more layers of interest and the plurality of parameters of the graph neural network during the embedding the multi-relational graph. For example, monitoring module 214, can observe or monitor the process the graph neural network undergoes during embedding and record the outcomes analyzing the score aggregations in an attention based GNN. At step 310 generate a comprehension score for each of a plurality of relations in the multi-relational graph, based on the monitoring. For example, monitoring module 214 can generate a comprehension score based on an analysis or observation and recording of the aggregated attention scores or weights of GNN 205. Further, monitor module 214 may compare the original scores or weights against the scores or weights during training or further yet, compare the weights against the final weights or scores obtained. At step 312 generating a ranked relation list, based on the comprehension score. For example, monitoring module 214 can rank the relations based on the generated comprehension score. At step 314, Select (e.g., infers or determine) a generalized relation for each relation below a ranking threshold. For example, relation generalization module 216 can determine a generalization for relations below a ranking score or place in the ranked list or with a comprehension score below a threshold. Relation generalization module 216 can find a relation associated between two entities based on a hierarchical knowledge base where the relation is a broader more general term, but within the same range. This may result in GNN 205 being able to more effectively learn the relation and improve the generated embedding of the multi-relation graph due to the better understanding of the relation. At step 316, generate a first updated multi-relation graph based on the generated generalized relation. For example, relation generalization module 216 can replace the relations with the generated generalizations within the multi-relational graph.

The descriptions of the various embodiments of the present invention have been presented for purposes of illustration, however, they are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating an updated multi-relational graph neural network, the computer-implemented method comprising:
receiving, at a definition module an input, wherein the input is a model architecture of a graph neural network, model type of the graph neural network, a hierarchy/ontology/taxonomy of relations or entities, and
identifying. by the definition module one or more layers of interest in the graph neural network and a plurality of parameters to monitor, based on the model architecture and model type;
embedding, by the graph neural network, a multi-relational graph, wherein the multi-relational graph comprises a plurality of entities and relations between entities;
monitoring, by the monitoring module, the one or more layers of interest and the plurality of parameters of the graph neural network embedding a multi-relational graph;
generating, by the monitoring module, a comprehension score for each of a plurality of relations in the multi-relational graph, based on the monitoring;
generating, by the monitoring module, a ranked relation list, based on the comprehension score;
generating, by a relation generalization module, a more general relation for each relation below a ranking threshold, wherein the more general relation is taken from the input hierarchy/ontology/taxonomy of relations or entities;
generating, by the relation generalization module, a first updated multi-relation graph based on the generated generalized relation; and
embedding the first updated multi-relational graph, based on the graph neural network.

2. The computer implemented method of claim 1, further comprising, monitoring, by the monitoring module, the one or more layers of interest and the plurality of parameters of the graph neural network embedding the updated multi-relational graph;
generating, by the monitoring module, a second comprehension score for each of a plurality of relations in the updated multi-relational graph, based on the monitoring of the updated multi-relational graph;
generating, by the monitoring module, a second ranked relation list, based on the second comprehension score;
generating, by a relation generalization module, a second more general relation for each relation below a ranking threshold, where the second more general relation is taken from the input hierarchy/ontology/taxonomy of relations or entities;
generating, by the relation generalization module, a second updated multi-relation graph based on the generated generalized relation from the second ranked relation list; and
embedding the second updated multi-relational graph, based on the graph neural network.

3. The computer implemented method of claim 1, wherein the graph neural network model is a graph attention network.

4. The computer implemented method of claim 3, wherein the monitored parameters are attention scores.

5. The computer implemented method of claim 1, wherein the graph neural network model is a graph convolutional network.

6. The computer-implemented method of claim 5, wherein the monitored parameters are convolutional weights.

7. The computer implemented method of claim 1, wherein the input further comprises a set of optional parameters and function to configure the ranking and generalization of relations.

8. A computer system for generating an updated multi-relational graph neural network, the system comprising:
one or more computer processors;
one or more computer readable storage devices; and
computer program instructions stored on the one or more computer readable storage devices, executable by the one or more computer processors to perform functions comprising:
receiving, at a definition module an input, wherein the input is a model architecture of a graph neural network, model type of the graph neural network, a hierarchy/ontology/taxonomy of relations or entities, and
identifying. by the definition module one or more layers of interest in the graph neural network and a plurality of parameters to monitor, based on the model architecture and model type;
embedding, by the graph neural network, a multi-relational graph, wherein the multi-relational graph comprises a plurality of entities and relations between entities;
monitoring, by the monitoring module, the one or more layers of interest and the plurality of parameters of the graph neural network embedding a multi-relational graph;
generating, by the monitoring module, a comprehension score for each of a plurality of relations in the multi-relational graph, based on the monitoring;
generating, by the monitoring module, a ranked relation list, based on the comprehension score;
generating, by a relation generalization module, a more general relation for each relation below a ranking threshold, wherein the more general relation is taken from the input hierarchy/ontology/taxonomy of relations or entities;
generating, by the relation generalization module, a first updated multi-relation graph based on the generated generalized relation; and
embedding the first updated multi-relational graph, based on the graph neural network.

9. The computer system of claim 8, further comprising computer program instructions executable by the one or more computer processors to perform functions comprising,
monitoring, by the monitoring module, the one or more layers of interest and the plurality of parameters of the graph neural network embedding the updated multi-relational graph;
generating, by the monitoring module, a second comprehension score for each of a plurality of relations in the updated multi-relational graph, based on the monitoring of the updated multi-relational graph;
generating, by the monitoring module, a second ranked relation list, based on the second comprehension score;
generating, by a relation generalization module, a second more general relation for each relation below a ranking threshold, where the second more general relation is taken from the input hierarchy/ontology/taxonomy of relations or entities;
generating, by the relation generalization module, a second updated multi-relation graph based on the generated generalized relation from the second ranked relation list; and
embedding the second updated multi-relational graph, based on the graph neural network.

10. The computer system of claim 8, wherein the graph neural network model is a graph attention network.

11. The computer system of claim 10, wherein the monitored parameters are attention scores.

12. The computer system of claim 8, wherein the graph neural network model is a graph convolutional network.

13. The computer system of claim 12, wherein the monitored parameters are convolutional weights.

14. The computer system of claim 8, wherein the input further comprises a set of optional parameters and function to configure the ranking and generalization of relations.

15. A computer program product for generating an updated multi-relational graph, the computer program product comprising:
a computer readable storage device having program instructions embodied therewith, the program instructions executable by a computer processor to cause the computer processor to perform a function, the function comprising:
receiving, at a definition module an input, wherein the input is a model architecture of a graph neural network, model type of the graph neural network, a hierarchy/ontology/taxonomy of relations or entities, and
identifying. by the definition module one or more layers of interest in the graph neural network and a plurality of parameters to monitor, based on the model architecture and model type;
embedding, by the graph neural network, a multi-relational graph, wherein the multi-relational graph comprises a plurality of entities and relations between entities;
monitoring, by the monitoring module, the one or more layers of interest and the plurality of parameters of the graph neural network embedding a multi-relational graph;
generating, by the monitoring module, a comprehension score for each of a plurality of relations in the multi-relational graph, based on the monitoring;
generating, by the monitoring module, a ranked relation list, based on the comprehension score;
generating, by a relation generalization module, a more general relation for each relation below a ranking threshold, wherein the more general relation is taken from the input hierarchy/ontology/taxonomy of relations or entities;
generating, by the relation generalization module, a first updated multi-relation graph based on the generated generalized relation; and
embedding the first updated multi-relational graph, based on the graph neural network.

16. The computer program product of claim 15, further comprising program instructions executable by the computer processors to perform functions comprising,
monitoring, by the monitoring module, the one or more layers of interest and the plurality of parameters of the graph neural network embedding the updated multi-relational graph;
generating, by the monitoring module, a second comprehension score for each of a plurality of relations in the updated multi-relational graph, based on the monitoring of the updated multi-relational graph;
generating, by the monitoring module, a second ranked relation list, based on the second comprehension score;
generating, by a relation generalization module, a second more general relation for each relation below a ranking threshold, where the second more general relation is taken from the input hierarchy/ontology/taxonomy of relations or entities;
generating, by the relation generalization module, a second updated multi-relation graph based on the generated generalized relation from the second ranked relation list; and
embedding the second updated multi-relational graph, based on the graph neural network.

17. The computer program product of claim 12, wherein the graph neural network model is a graph attention network.

18. The computer program product of claim 17, wherein the monitored parameters are attention scores.

19. The computer program product of claim 15, wherein the graph neural network model is a graph convolutional network.

20. The computer program product of claim 19, wherein the monitored parameters are convolutional weights.
